(19) United States
(12) Patent Application Publication
(10) Pub. No.: US 2003/0158891 A1
(43) Pub. Date: Aug. 21, 2003

(54) Utilizing mobile devices as a communication proxy for non-connected terminals

(75) Inventors: Jonathan L. Lei, Goleta, CA (US); Brian J. Fox, Goleta, CA (US)

Correspondence Address: PILLSBURY WINTHROP LLP, Suite 2800, 725 South Figueroa, Los Angeles, CA, 90017-5406, US

(73) Assignee: WARP 9 INC.

(21) Appl. No.: 10/080,086

(22) Filed: Feb. 21, 2002

(51) Int. Cl. H04Q 7/24; G06F 15/16

(52) U.S. Cl. 709/203; 370/338

(57) ABSTRACT

A wireless network system includes a server system connected to a network. An electronic device is provided having a wireless transceiver adapted to communicate via at least one of light transmission and radio frequency (RF) transmission. A portable wireless device is provided having a wireless connection to the network. The portable wireless device is adapted to communicate wirelessly with the electronic device. The electronic device communicates with the server system over the network through the portable wireless device. The electronic device may conduct real-time and/or non-real-time transactions with the server system by utilizing the portable wireless device as a communication proxy.

### BACKGROUND OF THE INVENTION

1. Field of the Invention

The present invention generally relates to a system and method of conducting wireless network transactions. More specifically, the present invention relates to a system and method that utilizes the wireless network connection of a portable wireless device to conduct transactions with a server system on behalf of a device not directly connected to the server system.

2. Discussion of the Related Art

The number of cellular telephones worldwide will soon eclipse the number of traditional landline telephones. By 2006, there will be 1.6 billion cellular telephone subscribers and just 963 million fixed-line subscribers. The Accenture Institute for Strategic Change claims that the worldwide market for Web-connected wireless devices will grow 630% between 2001 and 2006.

Although Internet connectivity is becoming more and more ubiquitous, the costs of individually connecting, for example, each device in a factory, each vending machine on the street, or each secured doorway in a building are shockingly prohibitive.

However, people are growing to expect the convenience that comes from being in an always Internet-connected state. Receiving time-sensitive information such as news, weather, stock prices, etc., on a cellular telephone or a handheld wireless device, utilizing a personal mobile device to purchase fuel, food, movie tickets, or to pay tolls, for example, and supplementing back-end systems in an enterprise with a constant flow of real-time information about the location of goods, status of invoices and payments, and the location and availability of employees are all examples of the convenience that people need, and in fact, expect from the world of current technology.

To maximize the benefits of the Internet, traditional interactive terminals and devices, such as kiosks, vending machines, and other point-of-sale terminals are being equipped with a dedicated Internet connection for real-time authorization, processing, and authentication of transactions, such as buying a soda or gaining access through a secured doorway.

Meanwhile, devices are becoming smarter each day. Open operating systems such Sun Computer's Java, Palm OS, Microsoft Pocket PC, Symbian, and others are making it easier for developers to write and deploy software on common mobile devices, such as cellular telephones and personal digital assistants (PDAs). Such devices almost always have multiple connection choices, including local connections implemented via InfraRed or Bluetooth (Specification of the Bluetooth System, Version 1.1, dated Feb. 22, 2001, by the Bluetooth Special Interest Group) and wide area connections, implemented via code-division multiple access (CDMA) or Transmission Control Protocol/Internet Protocol (TCP/IP).

FIG. 1A illustrates a real-time processing terminal according to the prior art. When real-time processing is required, such as in payment/fund verification, or in identity verification utilizing a handheld wireless device, for example, a host device (e.g., a point of sale terminal) is connected to the Internet or a wide area network (WAN) by a separate and dedicated connection. The handheld device, such as a cellular telephone, a PDA, a laptop computer, etc., communicates wirelessly with the host device, which transmits and receives data for the transaction over a network (such as the Internet) to and from a server system that is adapted to process the transaction. Accordingly, the host device is required to have a direct connection to the network, be it landline or wireless, to which the server system is connected. The host device becomes the relay point for communication between the handheld device and the server system.

FIG. 1B illustrates a real-time vending machine system according to the prior art. The real-time vending machine system is not entirely Internet-related, but it is based on utilization of a wide area network (WAN) by a cellular telephone incorporated inside a vending machine (the point of sale terminal). In one particular application, a customer may be able to purchase a can of soda using his/her own cellular telephone. The vending machine has a unique telephone number that the customer dials on his/her own cellular telephone. A call to that number on the vending machine triggers the vending machine to ultimately release a soft drink. Prior to releasing the soft drink, the vending machine communicates with a remote server system over a wide area network (WAN), such as via Internet Protocol (IP), Cellular Digital Packet Data (CDPD), Global System for Mobile communications (GSM), etc., (i.e., via a landline connection or via a wireless connection) to conduct and process the transaction and charge the customer. For example, the cost of the drink may be billed to the customer's cellular telephone bill. The customer may interface with the vending machine itself to select the type of soda or item to be dispensed (e.g., pushing a button on the vending machine corresponding to the item), or, the cellular telephone may be the interface to which the customer makes his/her selection (e.g., the customer keys in a number corresponding to an item).

However, the existing approaches as illustrated in FIGS. 1A and 1B, for example, are prohibitively expensive to deploy on a massive scale. The recurring costs associated with, for example, a dedicated WAN connection (e.g., the Internet), and wireless connection fees, do not justify the advantages of such a connection. Accordingly, there is a need for a mobile wireless transaction system that is inexpensive to deploy, and yet permits transactions over wide area networks to be easily conducted.

### BRIEF DESCRIPTION OF THE DRAWINGS

FIG. 1A illustrates a real-time processing terminal according to the prior art;

FIG. 1B illustrates a real-time vending machine system according to the prior art;

FIG. 2 illustrates a processing system utilizing a shared network connection according to an embodiment of the present invention;

FIG. 3 illustrates a flow chart diagram of shared network wireless communication according to an embodiment of the present invention;

FIG. 4 illustrates a flow chart diagram of wireless communication by a portable wireless device according to an embodiment of the present invention; and

FIG. 5 illustrates a flow chart diagram of wireless communication by an electronic device according to an embodiment of the present invention.

### DETAILED DESCRIPTION

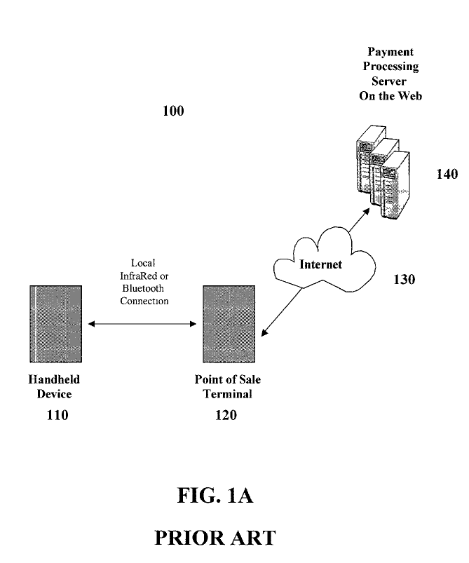

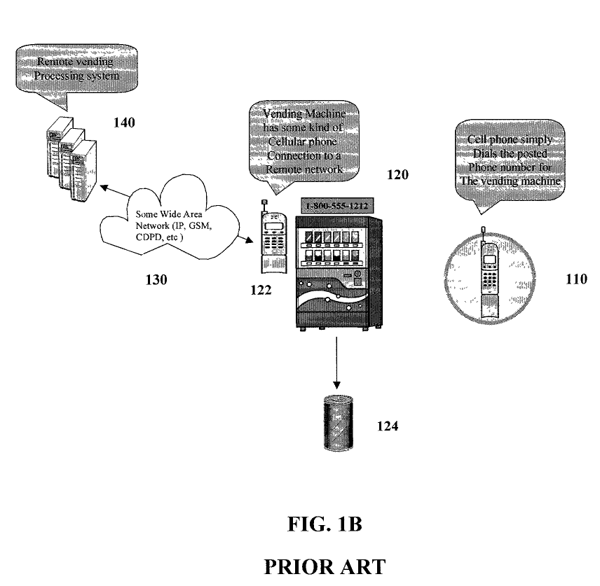

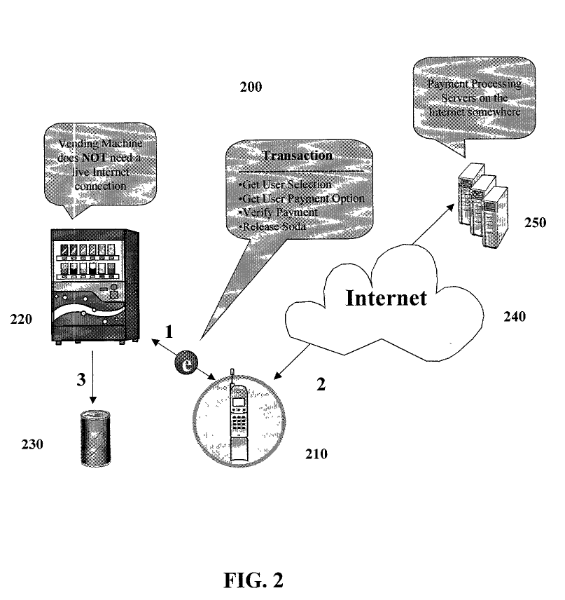

FIG. 2 illustrates a processing system utilizing a shared network connection according to an embodiment of the present invention. The processing system 200 includes an electronic device, node, or terminal 220, a portable wireless device 210, a server system(s) 250, and a wide 20 area network (WAN) 240, such as the Internet. The portable wireless device 210 may be a cellular telephone, a wireless-enabled personal digital assistant (PDA), a wireless-enabled laptop computer, an embedded computing device in a vehicle or in a “wearable” computer, or any suitable wireless-enabled (Internet-enabled or WAN-enabled) device. Some portable wireless devices 210 may have WAN access to the public Internet, while some may only have WAN access to a private network. The server systems 250 may be any system adapted to process a transaction, such as payment processing, identity verification, credit checking, access control, etc. The electronic device, node, or terminal 220 may be, for example, an interactive terminal or a point-of-sale terminal, such as a vending machine (the electronic device or node 220 being embedded into the vending machine), that is not connected to a server system 250. In the prior art systems as illustrated in FIGS. 1A and 1B, the point-of-sale terminal or host device has a dedicated direct connection to the server system, either via a landline connection or a wireless connection.

The server system 250 is connected to the wide area network 240, such as the Internet. The portable wireless device 210 also has a wireless connection to the network 240. The electronic device, node or terminal 220 includes a wireless transceiver adapted to communicate in a local wireless network, or Personal Area Network (PAN), with the portable wireless device 210. A PAN is a relatively small, dynamically created network that exists within a physically-limited space. Some examples of PANs include the Institute of Electrical and Electronics Engineers (IEEE) 802.11 wireless networking standards, the Bluetooth protocol, and InfraRed communication. Any suitable PAN standard or protocol may be utilized, though. The local wireless network or PAN may include as little as just two devices in wireless communication with each other.

According to an embodiment of the present invention, the electronic device, node, or terminal 220, the portable wireless device 210, and the server system 250 are configured so that the electronic device, node, or terminal 220 communicates with the server system 250 over the network 240 through the portable wireless device 210. In essence, the electronic device, node, or terminal 220 utilizes the bandwidth and wireless connection that is already present (or otherwise readily accessible) in the portable wireless device 210 to communicate with the server system 250 over the network 240, and the electronic device, node, or terminal 220 itself does not require a permanent and/or dedicated connection to the network 240 to communicate with the server system 250. Therefore, the costs of fitting (or retrofitting) each electronic device, node, or terminal 220 (such as one embedded into a vending machine) is reduced tremendously, in addition to the costs of the connection by the electronic device, node, or terminal 220 to the network 240. The portable wireless device 210 becomes a relay point for communication between the electronic device, node, or terminal 220 and the server system 250, and has a wireless transceiver to communicate wirelessly with the wireless transceiver of the electronic device, node, or terminal 220.

The communication between the electronic device, node, or terminal 220 and the server system 250 is preferably secured (e.g., encrypted) from that of the portable wireless device 210 so as to avoid tampering by a user of the portable wireless device 210 of the transaction. The electronic device, node, or terminal 220 preferably includes software/firmware that facilitates communication secured from the portable wireless device 210 (e.g., via encryption or other suitable techniques) between the electronic device, node, or terminal 220 and the server system 250. Software/firmware on the portable wireless device 210 is configured to receive data destined for the server system 250 from the electronic device, node, or terminal 220 via the PAN wireless connection, and then transmit/forward the data destined for the server system 250 over the network 240 to the server system 250 via a wireless connection to the network 240. Conversely, software/firmware on the portable wireless device 210 is configured to receive data destined for the electronic device, node, or terminal 220 from the server system 250 over the network 240 via the wireless connection. The portable wireless device 210 then forwards/transmits the data destined for the electronic device, node, or terminal 220 wirelessly via the PAN wireless connection to the electronic device, node, or terminal 220. By communicating through the portable wireless device 210, the electronic device, node, or terminal 220 does not need its own permanent or dedicated connection to the network 240 or directly to the server system 250.

The wireless connection established by the portable wireless device 210 to the wide area network 240 (or Internet) may be of any suitable wireless communication connection or protocol, including Transmission Control Protocol/Internet Protocol (TCP/IP), a satellite connection, Global System for Mobile communications (GSM), code-division multiple access (CDMA), time-division multiple access (TDMA), a 2.5 G connection such as the General Packet Radio Service (GPRS), a 3 G connection such as the Wideband Code-Division Multiple Access (WCDMA), or a Cellular Digital Packet Data (CDPD) connection. The server system 250 preferably includes software/firmware that communicates both with the electronic device, node, or terminal 220 and with any other software, firmware, or other network (e.g., Internet) server(s) in order to process the transaction. Moreover, communication between the electronic device, node, or terminal 220 and the server system 250 may utilize digital signatures to authenticate the communication, in addition to utilizing encryption to secure the communication.

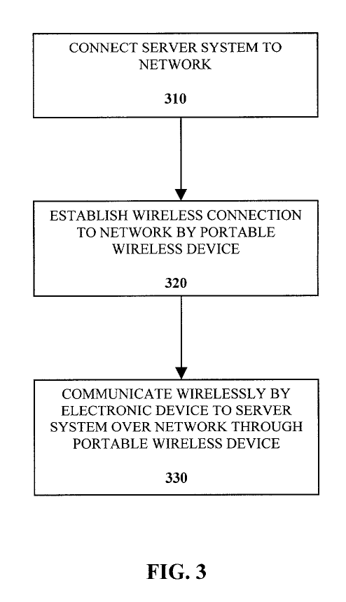

FIG. 3 illustrates a flow chart diagram of shared network wireless communication according to an embodiment of the present invention. A server system 250 is connected 310 to a network 240, such as the Internet. A portable wireless device 210 establishes 320 a wireless connection to the network 240. An electronic device, node, or terminal 220 communicates 330 wirelessly to the server system 250 over the network 240 through the portable wireless device 210.

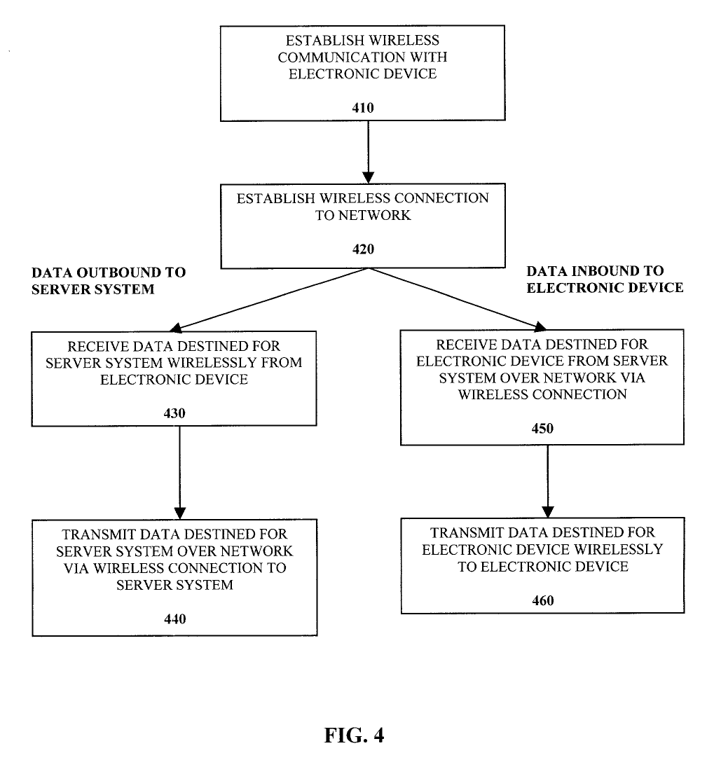

FIG. 4 illustrates a flow chart diagram of wireless communication by a portable wireless device according to an embodiment of the present invention. The portable wireless device 210 establishes 410 wireless communication with the electronic device, node, or terminal 220. The portable wireless device 210 may have a wireless transceiver to communicate wirelessly with the electronic device, node, or terminal 220. The portable wireless device 210 also establishes 420 a wireless connection to a network 240 with a wireless transceiver, which may be the same transceiver utilized to communicate wirelessly with the electronic device, node, or terminal 220. A server system 250 is connected to the network 240. The portable wireless device 210 is configured so that the electronic device, node, or terminal 220 communicates with the server system 250 over the network 240 through the portable wireless device 210.

For example, in the case of transmitting outbound data destined for the server system 250 by the electronic device, node, or terminal 220, the portable wireless device 210 receives 430 data destined for the server system 250 wirelessly from the electronic device, node, or terminal 220. The portable wireless device 210 then transmits/forwards 440 the data destined for the server system 250 over the network 240 via the wireless connection to the server system 250. In the case of receiving inbound data destined for the electronic device, node, or terminal 220, the portable wireless device 210 receives 450 data destined for the electronic device, node, or 20 terminal 220 from the server system 250 over the network 240 via the wireless connection. The portable wireless device 210 then transmits/forwards 460 the data destined for the electronic device, node, or terminal 220 wirelessly to the electronic device, node, or terminal 220. Preferably, communication between the electronic device, node, or terminal 220 and the server system 250 is secured (e.g., encrypted) from the portable wireless device 210 so that the portable wireless device 210 merely acts as a conduit passing data back and forth and cannot manipulate the communication.

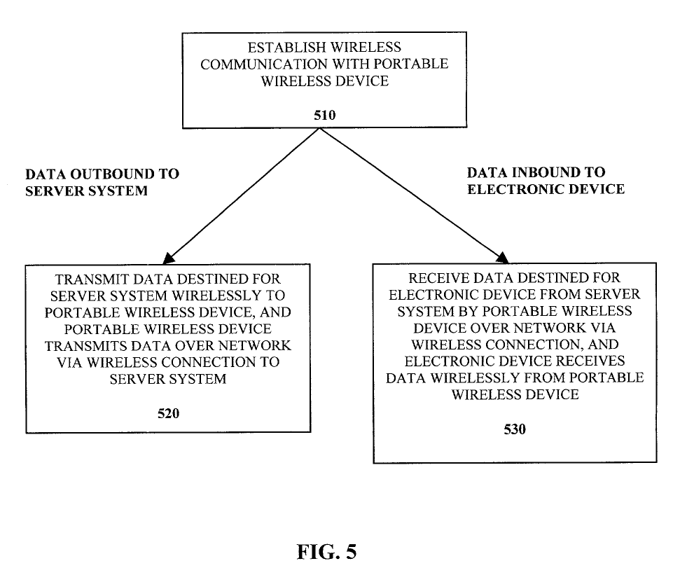

FIG. 5 illustrates a flow chart diagram of wireless communication by an electronic device according to an embodiment of the present invention. The electronic device, node, or terminal 220 establishes 510 wireless communication with a portable wireless device 210. The electronic device, node, or terminal 220 includes a wireless transceiver to communicate wirelessly with the portable wireless device 210. The portable wireless device 210 has a wireless connection to a network 240, and a server system 250 is connected to the network 240. The electronic device, node, or terminal 220 communicates with the server system 250 over the network 240 through the portable wireless device 210.

For example, in the case of transmitting outbound data destined for the server system 250, the electronic device, node, or terminal 220 transmits 520 data destined for the server system 250 wirelessly to the portable wireless device 210. The portable wireless device 210 then relays the data destined for the server system 250 over the network via the wireless connection to the server system 520. In the case of receiving inbound data destined for the electronic device, node, or terminal 220, the portable wireless device 210 receives the data destined for the electronic device, node, or terminal 220 over the network 240 via the wireless connection from the server system 250, and the electronic device, node, or terminal 220 receives 530 the data destined for the electronic device, node, or terminal 220 wirelessly from the portable wireless device 210.

Accordingly, the present invention enables the electronic device, node, or terminal 220 to take over and utilize the wireless connection to the network 240 available from the portable electronic device 210. In one particular application, any financial processing system may be utilized for a vending machine, or any other interactive terminal. The transaction may be billed to a customer's cellular telephone bill, a debit account, a credit card account, etc., at the choosing of either the customer or the vendor. The payment details may be pre-configured ahead of time, or a choice may be provided to the customer during the transaction. The user interface for the selection of soda from a vending machine, for example, may be on the vending machine itself, or on the screen of the customer's portable wireless device 210. A dispenser on the vending machine dispenses an item when approval is received from the server system 250 after successful payment verification. During the transaction between the vending machine and the server system, telemetry data (such as inventory information, temperature, etc.) of the vending machine may be transmitted with (“piggy-backed” onto) transaction data from the vending machine destined to the server system.

In a mobile vending application, any point-of-sale transaction may implement the system and method of the present invention. Whether the point-of-sale terminal 220 is supposed to accept credit cards, debit cards, membership cards, or other forms of payment, the present invention does not require the terminal 220 to have a dedicated and separate network connection. For example, credit card processing terminals at the grocery store implementing the present invention need not a network connection to process a customer's payment. The customer simply points his/her WAN-connected portable wireless device 210 at the terminal 220, selects the payment information locally on the wireless device, or from some remote secured server, and submits the transaction to the point-of-sale terminal 220. The point-of-sale terminal 220 packages the transaction accordingly with the user's payment information and sends it to a remote server system 250 for processing, the information being transmitted through the portable wireless device 210 serving as a relay point. The remote server system 250 sends back a result data package to the portable wireless device 210, which then forwards/transmits the result data package to the point-of-sale terminal 220.

The user interface of an interactive terminal 220 may be on the terminal 220 itself, in which case the user just needs to enable his/her portable wireless device 210 to permit the terminal 220 to gain access to the wireless WAN connection of the portable wireless device 210. Alternatively, the user interface may be on the portable wireless device 210 in the form of, for example, a Wireless Application Protocol (WAP), HyperText Markup Language (HTML) Web page, or any other suitable protocol. In the latter case, the interactive terminal 220 is a “black box” having a PAN connection to communicate wirelessly with the portable wireless device 210.

In yet another application, the system and method of the present invention may be implemented in keyless entry systems, which may be deployed more cost effectively. Instead of having a dedicated WAN connection to a secured doorway, a non-connected access terminal 220 with all of the proper hardware and software to control a door may be utilized. Wide area networks are not limited to just the public Internet, but may also encompass other network types, such as a government's intranet network to track access to secured doors inside a government building, for example. The user arrives at a locked door, points his/her WAN-connected portable wireless device 210 and enters his/her access code (e.g., a Personal Identification Number (PIN)). The access terminal 220 packages the PIN number as an authorization transaction and sends it to a remote server system 250 through the WAN connection on the user's portable wireless device 210. The authorization transaction is secured from the portable wireless device 210. The result is transmitted back to the access terminal 220 from the remote server system 250 to the portable wireless device 210, and ultimately to the access terminal 220. The result is also secured from the portable wireless device 210. This approach is better than the existing magnetic card or Radio Frequency Identification (RFID) solution because the doorway does not require a separate or dedicated network connection. Moreover, reprogramming of security levels may be performed with a central server system 250 with little or no modifications to the access terminal 220 at the door.

Moreover, the system and method of the present invention may be implemented in systems and devices in a factory setting. For example, rather than connecting every single data-monitoring and data-collecting device in a large factory floor to a permanent WAN to achieve a fully-connected information network, implementation of the present invention greatly reduces the amount of infrastructure and management costs associated with a fully-connected data network. In one particular embodiment, there are mobile members and stationary members of the overall data network. The mobile members include with them a portable wireless device 210 having a WAN connection to a remote server system 250, as well as a PAN connection to local/stationary devices 220. Examples of mobile members include humans with “smart” handheld or cellular telephones 210, or vehicles, such as a forklift, having a portable wireless device 210 incorporated therein. The mobile members with both PAN and WAN connections (via the portable wireless device 210) become a communication proxy for the stationary members (stationary nodes) 220 of the data network 200. Mobile members with only PAN connections are capable of being a communication proxy for non-real-time transactions (acting as an intermediary carrier of data from one stationary member to a member (either stationary or mobile) having a WAN connection to the server system 250. Some examples of stationary members may include traffic monitoring boxes, doorway entry and exit counting devices, factory machines with telemetry data, and environmental sensors. Therefore, instead of equipping all of the stationary members 220 with a permanent connection, stationary members 220 may be equipped with a relatively inexpensive PAN connection transceivers, utilizing, for example, InfraRed communication or the Bluetooth protocol.

In one example, a stationary member 220 collects various information (i.e., its status, serviceability, health, maintenance requirements, etc.) in the course of its duties. When the stationary member 220 needs to communicate with a remote server system 250 for data upload or download, it detects for a mobile member 210 within its PAN. When a mobile member 210, such as a human technician or a forklift comes within the stationary member's 220 PAN, the stationary member 220 initiates communication with the mobile member 210 and utilizes the mobile member's 210 wireless connection to the WAN 240 to communicate with the remote server system 250 in real time.

In another example, a delayed non-real-time transaction may be conducted utilizing the present invention. A stationary member 220 collects various information in the course of its duties. When the stationary member needs to transmit data to a remote server system 250, it looks for the presence of a mobile member 210 within its PAN. When the mobile member 210, such as a human technician or a forklift comes within the stationary member's 220 PAN, the stationary member 210 transmits a fully self-described data package (similar to that of a self-addressed stamped envelope). The mobile member 210, at its convenience, communicates with the remote server system 250 and delivers the self-described data package to the server system 250. If the mobile member 210 has both a PAN connection and a WAN connection, then it is possible for it to become a proxy for real-time transactions. If the mobile member 210 only has a PAN connection, then it is capable of being a proxy for non-real-time transactions. In the latter case, the mobile member 210 has to communicate with a PAN+WAN mobile member 210, a WAN-permanently-connected stationary member, or directly with the server system 250 via a PAN connection in order to complete the transaction.

When the server system 250 has data destined for a stationary member 220, the server system 250 may determine a mobile member 210 that is likely to pass by that designated stationary member 220. Such a mobile member 210 may be a forklift that has a standard route that takes it past the designated stationary member 220. The remote server system 250 creates a fully self-described data package for the stationary member 220 and transmits it to the mobile member 210. The mobile member 210 travels within the designated stationary member's 220 PAN and detects the presence of the stationary member 220 in the PAN. The mobile member 210 then delivers the data package from the server system 250 to the designated stationary member 220 over the PAN.

Accordingly, the present invention facilitates the interaction and transaction between a portable wireless device 210 and an electronic device, node, or terminal 220 by permitting the electronic device, node, or terminal 220 to utilize the Internet or WAN connection on the portable wireless device 210 to complete transactions over a wide area network 240 with a server system 250. One advantage is that the electronic device, node, or terminal 220 is not permanently connected to the wide area network 240 or the server system 250, which is more cost effective.

While the description above refers to particular embodiments of the present invention, it will be understood that many modifications may be made without departing from the spirit thereof. The accompanying claims are intended to cover such modifications as would fall within the true scope and spirit of the present invention. The presently disclosed embodiments are therefore to be considered in all respects as illustrative and not restrictive, the scope of the invention being indicated by the appended claims, rather than the foregoing description, and all changes that come within the meaning and range of equivalency of the claims are therefore intended to be embraced therein.

What is claimed is:

1. A wireless network system, comprising:
a server system connected to a network;
an electronic device having a wireless transceiver adapted to communicate via at least one of light transmission and radio frequency (RF) transmission; and
a portable wireless device having a wireless connection to the network, wherein the portable wireless device is adapted to communicate wirelessly with the electronic device, and the electronic device communicates with the server system over the network through the portable wireless device.

2. The wireless network system according to claim 1, wherein communication between the electronic device and the server system is secured from the portable wireless device.

3. The wireless network system according to claim 1, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

4. The wireless network system according to claim 1, wherein the electronic device communicates with the server system over the network through the portable wireless device by transmitting data destined for the server system wirelessly to the portable wireless device, and the portable wireless device transmits the data destined for the server system over the network via the wireless connection to the server system.

5. The wireless network system according to claim 1, wherein the electronic device communicates with the server system over the network through the portable wireless device by receiving data destined for the electronic device transmitted from the server system over the network to the portable wireless device via the wireless connection, and the portable wireless device transmits the data destined for the electronic device wirelessly to the electronic device.

6. The wireless network system according to claim 1, wherein the electronic device lacks a permanent connection to the network.

7. The wireless network system according to claim 1, wherein the electronic device only communicates with the server system indirectly through the portable wireless device.

8. The wireless network system according to claim 1, wherein the server system is adapted to process a transaction.

9. The wireless network system according to claim 1, wherein the portable wireless device includes a second wireless transceiver to communicate wirelessly with the wireless transceiver of the electronic device.

10. The wireless network system according to claim 1, wherein the network is a wide area network (WAN).

11. The wireless network system according to claim 1, wherein communication between the electronic device and the server system is packet-based.

12. A method of wireless communication, comprising:
connecting a server system to a network;
establishing a wireless connection to the network by a portable wireless device; and
communicating wirelessly by an electronic device to the server system over the network through the portable wireless device, wherein the electronic device communicates directly with the portable wireless device via at least one of light transmission and radio frequency (RF) transmission.

13. The method according to claim 12, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

14. The method according to claim 12, wherein communication between the electronic device and the server system is secured from the portable wireless device.

15. The method according to claim 12, further including processing a transaction by the server system.

16. The method according to claim 12, further including:
transmitting data destined for the server system wirelessly by the electronic device to the portable wireless device; and
transmitting the data destined for the server system over the network by the portable wireless device via the wireless connection to the server system.

17. The method according to claim 12, further including:
transmitting data destined for the electronic device from the server system over the network to the portable wireless device via the wireless connection; and
transmitting the data destined for the electronic device wirelessly from the portable wireless device to the electronic device.

18. The method according to claim 12, wherein the electronic device lacks a permanent connection to the network.

19. The method according to claim 12, wherein the electronic device only communicates with the server system indirectly through the portable wireless device.

20. The method according to claim 12, wherein the network is a wide area network (WAN).

21. The method according to claim 12, wherein communication between the electronic device and the server system is packet-based.

22. A portable wireless device, comprising:
a first wireless transceiver to communicate wirelessly with an electronic device, wherein the first wireless transceiver is adapted to communicate via at least one of light transmission and radio frequency (RF) transmission; and
a second wireless transceiver having a wireless connection to a network, wherein a server system is connected to the network, and the portable wireless device is adapted to permit the electronic device to communicate with the server system over the network through the portable wireless device.

23. The portable wireless device according to claim 22, wherein the first wireless transceiver communicates wirelessly with the electronic device via a protocol selected from the group consisting of InfraRed communication, Bluetooth protocol, and IEEE 802.11 protocol.

24. The portable wireless device according to claim 22, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

25. The portable wireless device according to claim 22, wherein the first wireless transceiver and the second wireless transceiver are a same device.

26. The portable wireless device according to claim 22, wherein the server system is adapted to process a transaction.

27. The portable wireless device according to claim 22, wherein the electronic device communicates with the server system over the network through the portable wireless device by transmitting data destined for the server system wirelessly to the portable wireless device, and the portable wireless device transmits the data destined for the server system over the network via the wireless connection to the server system.

28. The portable wireless device according to claim 22, wherein the electronic device communicates with the server system over the network through the portable wireless device by receiving data destined for the electronic device transmitted from the server system over the network to the portable wireless device via the wireless connection, and the portable wireless device transmits the data destined for the electronic device wirelessly to the electronic device.

29. The portable wireless device according to claim 22, wherein the electronic device lacks a permanent connection to the network.

30. The portable wireless device according to claim 22, wherein the electronic device only communicates with the server system indirectly through the portable wireless device.

31. The portable wireless device according to claim 22, wherein the network is a wide area network (WAN).

32. The portable wireless device according to claim 22, wherein the portable wireless device is a mobile telephone.

33. The portable wireless device according to claim 22, wherein the portable wireless device is a laptop computer.

34. The portable wireless device according to claim 22, wherein the portable wireless device is a p personal digital assistant (PDA).

35. The portable wireless device according to claim 22, wherein the portable device is selected from the group consisting of an embedded computing device in a vehicle, and an embedded computing device within a wearable computer.

36. The portable wireless device according to claim 22, wherein communication between the electronic device and the server system is packet-based.

37. A method of wireless communication by a portable wireless device, comprising:
establishing wireless communication with an electronic device via at least one of light transmission and radio frequency (RF) transmission;
establishing a wireless connection to a network, wherein a server system is connected to the network;
receiving data destined for the server system wirelessly from the electronic device;
transmitting the data destined for the server system over the network via the wireless connection to the server system;
receiving data destined for the electronic device from the server system over the network via the wireless connection; and
transmitting the data destined for the electronic device wirelessly to the electronic device.

38. The method according to claim 37, wherein communication between the electronic device and the server system is secured from the portable wireless device.

39. The method according to claim 37, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

40. The method according to claim 37, wherein the server system is adapted to process a transaction.

41. The method according to claim 37, wherein the electronic device only communicates with the server system indirectly through the portable wireless device.

42. The method according to claim 37, wherein the network is a wide area network (WAN).

43. The method according to claim 37, wherein communication between the electronic device and the server system is packet-based.

44. A program code storage device, comprising:
a machine-readable storage medium; and
machine-readable program code, stored on the machine readable storage medium, having instructions to
establish wireless communication with an electronic device via at least one of light transmission and radio frequency (RF) transmission,
establish a wireless connection to a network, wherein a server system is connected to the network,
receive data destined for the server system wirelessly from the electronic device,
transmit the data destined for the server system over the network via the wireless connection to the server system,
receive data destined for the electronic device from the server system over the network via the wireless connection, and
transmit the data destined for the electronic device wirelessly to the electronic device.

45. The program code storage device according to claim 44, wherein communication between the electronic device and the server system is secured from the portable wireless device.

46. The program code storage device according to claim 44, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Placket Radio Service (GPRS) connection, and a wideband code-division multiple access (WCDMA) connection.

47. The program code storage device according to claim 44, wherein the server system is adapted to process a transaction.

48. The program code storage device according to claim 44, wherein the electronic device only communicates with the server system indirectly through the portable wireless device.

49. The program code storage device according to claim 44, wherein the network is a wide area network (WAN).

50. The program code storage device according to claim 44, wherein communication between the electronic device and the server system is packet-based.

51. An electronic device to indirectly communicate wirelessly with a server system, comprising:
a wireless transceiver to communicate wirelessly via at least one of light transmission and radio frequency (RF) transmission with a portable wireless device having a wireless connection to a network, wherein the server system is connected to the network, and the electronic device communicates with the server system over the network through the portable wireless device.

52. The electronic device according to claim 51, wherein the wireless transceiver communicates wirelessly with the portable wireless device via a protocol selected from the group consisting of InfraRed communication, Bluetooth protocol, and IEEE 802.11 protocol.

53. The electronic device according to claim 51, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, and a Cellular Digital Packet Data (CDPD) connection, a General Packet Radio Service (GPRS) connection, and a wideband code-division multiple access (WCDMA) connection.

54. The electronic device according to claim 51, wherein communication between the electronic device and the server system is secured from the portable wireless device.

55. The electronic device according to claim 51, wherein the electronic device communicates with the server system over the network through the portable wireless device by transmitting data destined for the server system wirelessly to the portable wireless device, and the portable wireless device transmits the data destined for the server system over the network via the wireless connection to the server system.

56. The electronic device according to claim 51, wherein the electronic device communicates with the server system over the network through the portable wireless device by receiving data destined for the electronic device transmitted from the server system over the network to the portable wireless device via the wireless connection, and the portable wireless device transmits the data destined for the electronic device wirelessly to the electronic device.

57. The electronic device according to claim 51, wherein electronic device lacks a permanent connection to the network.

58. The electronic device according to claim 51, wherein the electronic device only communicates with the server system indirectly through the portable wireless device.

59. The electronic device according to claim 51, wherein the server system is adapted to process a transaction.

60. The electronic device according to claim 51, wherein the network is a wide area network (WAN).

61. The electronic device according to claim 51, wherein the electronic device is embedded into a vending machine.

62. The electronic device according to claim 5 1, wherein communication between the electronic device and the server system is packet-based.

63. A method of wireless communication by an electronic device, comprising:
establishing wireless communication with a portable wireless device via at least one of light transmission and radio frequency (RF) transmission, wherein the portable wireless device has a wireless connection to a network, and a server system is connected to the network;
transmitting data destined for the server system wirelessly to the portable electronic device, wherein the portable wireless device transmits the data destined for the server system over the network via the wireless connection to the server system; and
receiving data destined for the electronic device from the server system, wherein the portable wireless device receives the data destined for the electronic device from the server system over the network via the wireless connection and transmits the data destined for the electronic device wirelessly to the electronic device.

64. The method according to claim 63, wherein communication between the electronic device and the server system is secured from the portable wireless device.

65. The method according to claim 63, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

66. The method according to claim 63, wherein the server system is adapted to process a transaction.

67. The method according to claim 63, wherein the electronic device only communicates with the server system indirectly through the portable wireless device.

68. The method according to claim 63, wherein the network is a wide area network (WAN).

69. The method according to claim 63, wherein communication between the electronic device and the server system is packet-based.

70. A program code storage device, comprising:
a machine-readable storage medium; and
machine-readable program code, stored on the machine-readable storage medium, having instructions to
establish wireless communication with a portable wireless device via at least one of light transmission and radio frequency (RF) transmission, wherein the portable wireless device has a wireless connection to a network, and a server system is connected to the network,
transmit data destined for the server system wirelessly to the portable electronic device, wherein the portable wireless device transmits the data destined for the server system over the network via the wireless connection to the server system, and
receive data destined for the electronic device from the server system, wherein the portable wireless device receives the data destined for the electronic device from the server system over the network via the wireless connection and transmits the data destined for the electronic device wirelessly to the electronic device.

71. The program code storage device according to claim 70, wherein communication between the electronic device and the server system is secured from the portable wireless device.

72. The program code storage device according to claim 70, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

73. The program code storage device according to claim 70, wherein the server system is adapted to process a transaction.

74. The program code storage device according to claim 70, wherein the electronic device only communicates with the server system indirectly through the portable wireless device.

75. The program code storage device according to claim 70, wherein the network is a wide area network (WAN).

76. The program code storage device according to claim 70, wherein communication between the electronic device and the server system is packet-based.

77. A vending machine, comprising:
a wireless transceiver to communicate wirelessly via at least one of light transmission and radio frequency (RF) transmission with a portable wireless device having a wireless connection to a network, wherein a server system is connected to the network, and the wireless transceiver communicates with the server system over the network through the portable wireless device; and
a dispenser to dispense an item when an approval is received from the server system over the network through the portable wireless device.

78. The vending machine according to claim 77, wherein the wireless transceiver communicates wirelessly with the portable wireless device via a protocol selected from the group consisting of InfraRed communication, Bluetooth protocol, and IEEE 802.11 protocol.

79. The vending machine according to claim 77, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

80. The vending machine according to claim 77, wherein the approval is transmitted from the server system to the vending machine after successful payment verification.

81. The vending machine according to claim 77, wherein communication between the vending machine and the server system is secured from the portable wireless device.

82. The vending machine according to claim 77, wherein the vending machine communicates with the server system over the network through the portable wireless device by transmitting data destined for the server system wirelessly to the portable wireless device, and the portable wireless device transmits the data destined for the server system over the network via the wireless connection to the server system.

83. The vending machine according to claim 77, wherein the vending machine communicates with the server system over the network through the portable wireless device by receiving data destined for the vending machine transmitted from the server system over the network to the portable wireless device via the wireless connection, and the portable wireless device transmits the data destined for the vending machine wirelessly to the vending machine.

84. The vending machine according to claim 77, wherein the vending machine lacks a permanent connection to the network.

85. The vending machine according to claim 77, wherein the vending machine only communicates with the server system indirectly through the portable wireless device.

86. The vending machine according to claim 77, wherein the server system is adapted to process a transaction.

87. The vending machine according to claim 77, wherein the wireless transceiver transmits telemetry data destined to the server system along with transaction data destined to the server system transmitted from the wireless transceiver.

88. The vending machine according to claim 77, wherein the network is a wide area network (WAN).

89. The vending machine according to claim 77, wherein communication between the wireless transceiver and the server system is packet-based.

90. A method of wireless communication for payment processing, comprising:
connecting a payment processing server system to a network;
establishing a wireless connection to the network by a portable wireless device;
communicating wirelessly by a terminal to the payment processing server system over the network through the portable wireless device, wherein the terminal communicates directly with the portable wireless device via at least one of light transmission and radio frequency (RF) transmission; and
processing a transaction by the payment processing server system.

91. The method according to claim 90, further including communicating wirelessly with the portable wireless device by the terminal.

92. The method according to claim 90, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

93. The method according to claim 90, wherein communication between the terminal and the payment processing server system is secured from the portable wireless device.

94. The method according to claim 90, further including:
transmitting data destined for the payment processing server system wirelessly by the terminal to the portable wireless device; and
transmitting the data destined for the payment processing server system over the network by the portable wireless device via the wireless connection to the server system.

95. The method according to claim 90, further including:
transmitting data destined for the terminal from the payment processing server system over the network to the portable wireless device via the wireless connection; and
transmitting the data destined for the terminal wirelessly from the portable wireless device to the terminal.

96. The method according to claim 90, wherein the terminal lacks a permanent connection to the network.

97. The method according to claim 90, wherein the terminal only communicates with the payment processing server system indirectly through the portable wireless device.

98. The method according to claim 90, wherein the network is a wide area network (WAN).

99. The method according to claim 90, wherein communication between the terminal and the payment processing server system is packet-based.

100. A method of reporting status information of a terminal, comprising:
establishing a wireless connection to a network by a portable wireless device, wherein a server system is connected to the network;
establishing a local wireless connection between the portable wireless device and the terminal, wherein the terminal communicates directly with the portable wireless device via at least one of light transmission and radio frequency (RF) transmission;
requesting the status information by the portable wireless device from the terminal;
transmitting the status information from the terminal to the portable electronic device; and
transmitting the status information from the portable electronic device over the network to the server system via the wireless connection.

101. The method according to claim 100, wherein communication between the terminal and the server system is secured from the portable wireless device.

102. The method according to claim 100, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

103. The method according to claim 100, further including:
transmitting data destined for the terminal from the server system over the network to the portable wireless device via the wireless connection; and
transmitting the data destined for the terminal wirelessly from the portable wireless device to the electronic device via the local wireless connection.

104. The method according to claim 100, wherein the terminal lacks a permanent connection to the network.

105. The method according to claim 100, wherein the terminal only communicates with the server system indirectly through the portable wireless device.

106. The method according to claim 100, wherein the network is a wide area network (WAN).

107. The method according to claim 100, wherein communication between the terminal and the server system is packet-based.

108. A method of keyless entry, comprising:
establishing a wireless connection to a network by a portable wireless device, wherein a server system is connected to the network;
establishing a local wireless connection by the portable wireless device with an access terminal, wherein the access terminal communicates directly with the portable wireless device via at least one of light transmission and radio frequency (RF) transmission;
transmitting an access code from the portable wireless device via the local wireless connection to the access terminal;
transmitting an authorization package including the access code from the access terminal via the local wireless connection to the portable wireless device;
transmitting the authorization package from the portable wireless device over the network to the server system via the wireless connection;
processing the authorization package by the server system to provide a result as to whether access is permitted;
transmitting the result from the server system over the network to the portable wireless device via the wireless connection;
transmitting the result from the portable wireless device wirelessly to the access terminal via the local wireless connection; and
granting access by the access terminal if the result indicates that access is permitted.

109. The method according to claim 108, wherein communication between the access terminal and the server system is secured from the portable wireless device.

110. The method according to claim 108, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

111. The method according to claim 108, wherein the access terminal lacks a permanent connection to the network.

112. The method according to claim 108, wherein the access terminal only communicates with the server system indirectly through the portable wireless device.

113. The method according to claim 108, wherein the network is a wide area network (WAN).

114. The method according to claim 108, wherein communication between the access terminal and the server system is packet-based.

115. A method of wireless communication by a stationary node, comprising:
collecting data to be transmitted to a server system connected to a network;
establishing wireless communication with a portable wireless device via at least one of light transmission and radio frequency (RF) transmission, wherein the portable wireless device has a wireless connection to the network; and
transmitting the data wirelessly to the portable wireless device, wherein the portable wireless device transmits the data to the server system over the network via the wireless connection to the server system.

116. The method according to claim 115, wherein communication between the stationary node and the server system is secured from the portable wireless device.

117. The method according to claim 115, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, and a Cellular Digital Packet Data (CDPD) connection, a General Packet Radio Service (GPRS) connection, and a wideband code-division multiple access (WCDMA) connection.

118. The method according to claim 115, wherein the stationary node only communicates with the server system indirectly through the portable wireless device.

119. The method according to claim 1 15, wherein the network is a wide area network (WAN).

120. The method according to claim 1 15, wherein communication between the stationary node and the server system is packet-based.

121. A method of non-real-time wireless communication by a stationary node, comprising:
collecting data to be transmitted to a server system connected to a network;
establishing wireless communication via a personal area network (PAN) with a portable wireless device via at least one of light transmission and radio frequency (RF) transmission; and
transmitting the data wirelessly to the portable wireless device via the personal area network (PAN), wherein the portable wireless device transmits the data over the network to the server system at a later time.

122. The method according to claim 121, wherein the network is a second personal area network (PAN) and the portable wireless device transmits the data directly to the server system over the second personal area network.

123. The method according to claim 121, wherein the network is a wide area network (WAN), and the portable wireless device transmits the data to a second portable wireless device having a wireless connection to the wide area network, and the second portable wireless device transmits the data over the wide area network via the wireless connection to the server system.

124. The method according to claim 121, wherein communication between the stationary node and the server system is secured from the portable wireless device.

125. The method according to claim 123, wherein the wireless connection is selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

126. The method according to claim 121, wherein communication via the personal area network (PAN) is via a protocol selected from the group consisting of InfraRed communication, Bluetooth protocol, and IEEE 802.11 protocol.

127. A method of non-real-time wireless communication to a designated stationary node, comprising:
selecting a portable wireless device that travels within a personal area network (PAN) of the designated stationary node; and
transmitting wirelessly, from a server system connected to a network, data for the designated stationary node over the network to the portable wireless device, wherein the portable wireless device travels within the personal area network (PAN) of the designated stationary node and transmits wirelessly the data to the designated stationary node over the personal area network via at least one of light transmission and radio frequency (RF) transmission.

128. The method according to claim 127, wherein the network is a second personal area network (PAN) and the portable wireless device receives the data directly from the server system over the second personal area network.

129. The method according to claim 127, wherein the network is a wide area network (WAN).

130. The method according to claim 127, wherein communication between the designated stationary node and the server system is secured from the portable wireless device.

131. The method according to claim 127, wherein communication over the wide area network (WAN) is via a connection selected from the group consisting of a Transmission Control Protocol/Internet Protocol (TCP/IP) connection, a satellite connection, a Global System for Mobile communications (GSM) connection, a code-division multiple access (CDMA) connection, a time-division multiple access (TDMA) connection, a Cellular Digital Packet Data (CDPD) connection, a General Packet Radio Service (GPRS) connection, and a wideband code-division multiple access (WCDMA) connection.

132. The method according to claim 127, wherein communication via the personal area network (PAN) is via a protocol selected from the group consisting of InfraRed communication, Bluetooth protocol, and IEEE 802.11 protocol.
